(19) United States
(12) Patent Application Publication
(10) Pub. No.: US 2015/0091765 A1
(43) Pub. Date: Apr. 2, 2015

(54) ELECTRICAL-MECHANICAL INTERFACE WITH ANTENNA ELEVATED ABOVE SKIN SURFACE

(71) Applicant: Google Inc., Mountain View, CA (US)

(72) Inventors: Melissa Frank, Los Altos, CA (US); Carson Lau, San Francisco, CA (US); Benjamin McLaughlin Gallant, Santa Cruz, CA (US)

(73) Assignee: Google Inc., Mountain View, CA (US)

(21) Appl. No.: 14/044,566

(22) Filed: Oct. 2, 2013

(51) Int. Cl. H01Q 1/27

(52) U.S. Cl. CPC H01Q 1/273
USPC 343/718

(57) ABSTRACT

A wearable device band may contain a plurality of flexible sections and rigid sections. A radio frequency circuit and a central processing unit may be located on respective rigid sections. An antenna may be located at a flexible section and may be a given distance away from the portion of the band that touches a user's skin when the wearable device is worn by a user. The flexible section may contain a grounding flap and also may be configured to stretch over a roller.

### BACKGROUND

Traditional consumer wearable devices such as wrist watches do not contain an antenna or, if they do contain one or more antennas, the communication via the antenna is not optimal due to the electrical interference caused by components of the wearable device itself or due to the user's skin surface. A component of the wearable device may cause an electrical interference if, for example, the component contains one or more electrical or metal components. An electrical component may generate electromagnetic signals that interfere with radio frequency signals transmitted and/or received by the antenna. Similarly, a user's skin may also cause a disruption in operation of the antenna as the user's skin may generate electromagnetic signals that interfere with radio frequency signals transmitted and/or received by the antenna. More specifically, a wearable device component or a user's skin may cause interference as a result of either electromagnetic induction or electromagnetic radiation emitted from the component or skin. Such effects may cause degradation of data or cause a reduction in signal strength.

### BRIEF SUMMARY

According to implementations of the disclosed subject matter, a device may contain a band that contains multiple flexible and rigid sections. A rigid section of the multiple rigid sections may contain a central processing unit (CPU) and another rigid section of the multiple rigid sections may contain a radio frequency (RF) circuit. A flexible section of the multiple flexible sections may be between the rigid section with the CPU and the rigid section with the RF circuit and may contain an antenna element. Alternatively, a first flexible section of the multiple flexible sections may be between the rigid section with the CPU and the rigid section with the RF circuit and a different flexible section adjacent to the rigid section with the RF circuit may contain the antenna element. The antenna element may contain a top side and a bottom side and the flexible section containing the antenna element may contain or roll over a roller that is located beneath the antenna element. The device may contain a grounding flap which may be integrated into the flexible section or may be attached to the flexible section via contact points.

Systems and techniques according to the present disclosure enable communication between a wearable device and one or more other devices with reduced interference from device components and/or a user's skin. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3a shows an example visualization corresponding to a wearable device with multiple flexible and rigid sections, according to an implementation of the disclosed subject matter.

FIG. 3b shows another example visualization corresponding to a wearable device with multiple flexible and rigid sections, according to an implementation of the disclosed subject matter.

FIG. 4 shows another example visualization corresponding to a wearable device with multiple flexible and rigid sections, according to an implementation of the disclosed subject matter.

FIG. 5a shows an example visualization corresponding to a flexible section with a roller, according to an implementation of the disclosed subject matter.

FIG. 5b shows another example visualization corresponding to a flexible section with a roller, according to an implementation of the disclosed subject matter.

### DETAILED DESCRIPTION

A wearable device that contains a band including multiple flexible and rigid sections as well as one or more antennas may allow the one or more antennas to transmit and/or receive signals to/from an external element with limited or no interference from device electronic or metal components and/or an electrical field presented by human skin. The antenna may be contained within a flexible section of the band such that the antenna is placed a minimum distance above a user's skin while the wearable device is worn. The flexible section may be adjacent to at least one rigid section containing a radio frequency circuit. The band may also contain a central processing unit on another rigid section. The flexible section containing the antenna may be between the two rigid sections containing the radio frequency circuit and the central processing unit. Alternatively, the flexible section may only be adjacent to the rigid section containing the radio frequency circuit without being located between that rigid section containing the radio frequency unit and another rigid section containing the central processing unit. The flexible section may contain or may be placed over a roller and the roller may enable the flexible section to bend above the roller when the wearable device is worn by a user. An antenna contained within the flexible section may either bend above the roller when the wearable device is worn or may maintain its shape while at least a portion of the flexible section containing the antenna bends over the roller. A grounding flap may be placed beneath the antenna to further decrease the effect of any electromagnetic field generated by the user's skin.

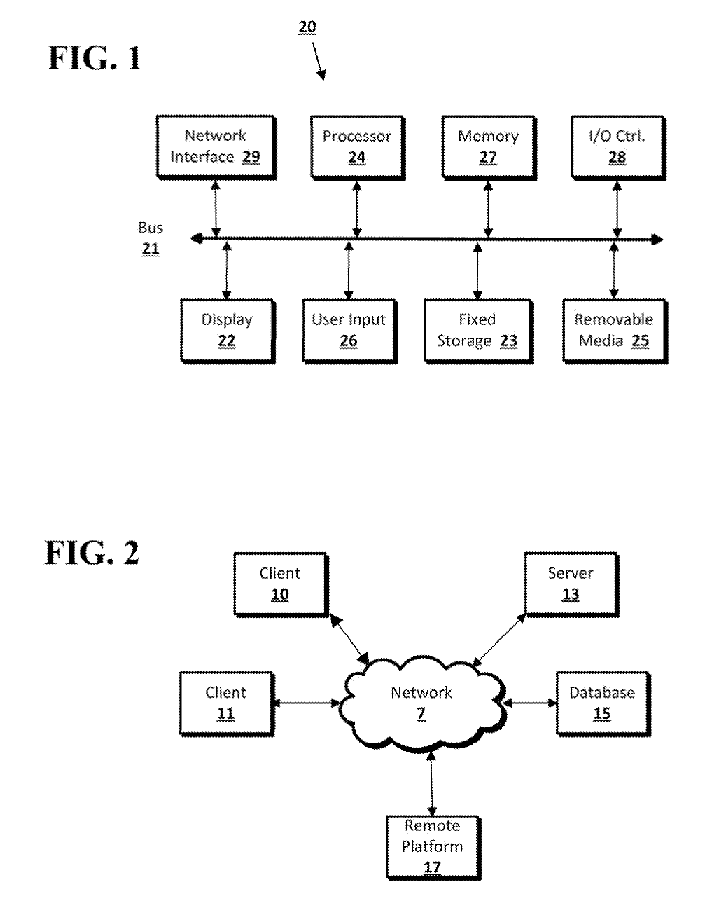

Implementations of the presently disclosed subject matter and/or a device in connection or communication with a device disclosed herein may be implemented in and used with a variety of component and network architectures. FIG. 1 is an example computer 20 suitable for implementing implementations of the presently disclosed subject matter or one or more devices in communication with devices disclosed herein. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

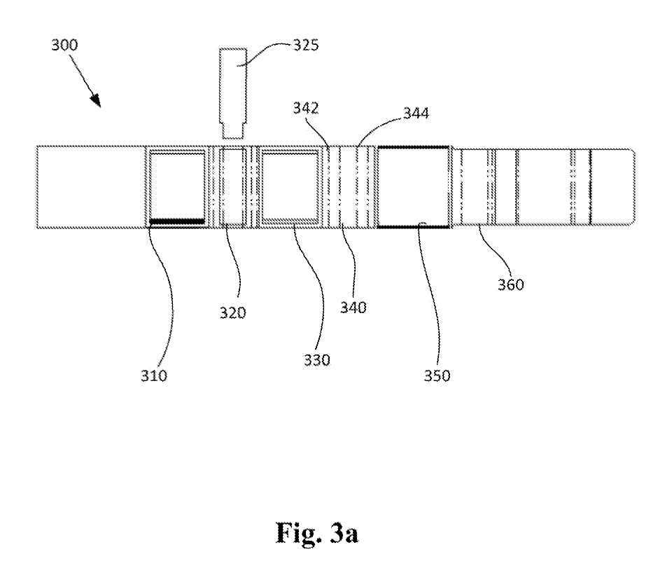

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., wearable devices, touchscreen devices, music players, document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as thermostats, local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

According to implementations of the disclosed subject matter, a wearable device may contain a band that may be configured to secure the wearable device onto a user's body. The wearable device may be any applicable device such as a communication device, a media device (e.g., a video playback device, an audio playback device, etc.), an interactive device (e.g., enables video game play, receives user input, provides an output based on user input, etc.), a web access device, or the like. The wearable device may be worn on any applicable portion of a user's body such as a user's wrist, arm, neck, head, leg, or the like. The band may secure the wearable device to a user's body in any applicable manner such as via a clasp, buckle, hook, fastener, or the like or via pressure or friction applied by the band onto the user.

The band may contain a plurality of sections, including rigid sections and flexible sections. A rigid section may be a section that contains an electric component and may not be elastic such that it cannot bend or stretch when the wearable device is worn by a user. More specifically, the wearable device band may be configured to exist in at least two modes: worn and not worn. The rigid section may maintain its structure regardless of whether the wearable device is worn or not worn. More specifically, even when the band is bent, the rigid section may maintain its structure such that neither the rigid section nor anything integrated onto/into the rigid section is stretched or bent.

A flexible section may be a section that is configured to bend or stretch and may contain an antenna, a grounding flap, and/or a roller, as disclosed herein. A flexible section may be between one or more rigid sections and at least some portion of a flexible section may change its structure when a band containing the flexible section changes its position from worn to not worn or vice versa. More specifically, at least a portion of a flexible section may bend or stretch when a force pulls the flexible section from one or more directions. The flexible section may stretch over a roller, as disclosed herein. As a specific example, a user may place a wrist watch on the user's wrist and pull two sections of the band toward each other to facilitate a connection joining the two sections. One or more flexible sections contained in the two sections of the band may be bent or stretched to facilitate the change in shape and/or the change in length of band necessary to facilitate the connection. Notably, here, the structure for one or more rigid sections may not change whereas the structure for at least a portion of the flexible sections may change to facilitate the different configurations of the band.

A rigid section may contain sub-rigid or sub-flexible section and/or any applicable electronic component such as an electronic circuit (e.g., a radio frequency circuit, a central processing unit, etc.), a display (e.g., a touchscreen display, a tactile display, an LED display, etc.), an audio speaker, soft buttons, hard buttons, or the like. Alternatively, a rigid section may not contain any additional components other than the material that makes up the rigid section.

A flexible section may contain sub-rigid or sub-flexible section and/or one or more components such as an electronic component, an antenna, a grounding flap, a roller, or the like. The components may be attached to a flexible section in any applicable manner such as by attaching with contact points integrated into the flexible section, by solder, by being disposed on, under, or within the flexible section or the like. Alternatively, a flexible section component may be integrated into the flexible section.

A wearable device band may contain a plurality of flexible sections and a plurality of rigid sections. A first rigid section may contain a central processing unit and second rigid section may contain a radio frequency circuit. It will be understood that although the present disclosure describes a first and a second rigid section, there may be multiple rigid sections that contain one or more central processing units and/or radio frequency circuits. The central processing unit may be in communication with the radio frequency circuit via any applicable technique such as wireless communication or wired communication. A central processing unit may be a hardware component that carries out computer based instructions by performing any applicable arithmetic, logical, processing or memory operation. The central processing unit may contain any applicable components such as transistors, electronic busses, power, or the like. A radio frequency circuit may be configured for any applicable application such as to receive and/or transmit radio frequency signals, amplify a signal, mix a signal, or the like.

According to an implementation of the disclosed subject matter, a wearable device band may contain a flexible section including an antenna and be located adjacent to a first rigid section. The rigid section may contain a radio frequency circuit that is in communication with the antenna. The antenna may be any applicable antenna configured to facilitate communication such as an RF antenna capable of transmitting and/or receiving radio signals. As a specific example, the antenna may be 2.4 GHz antenna configured to optimally transmit and receive signals at 2.4 GHz. The antenna may be integrated into the flexible region such that it is a part of the flexible section (e.g., integrated into the flexible section during production). Alternatively, the antenna may be joined with the flexible section in any applicable manner such as by connecting the antenna to connection points on the flexible section or by soldering an antenna onto the flexible section.

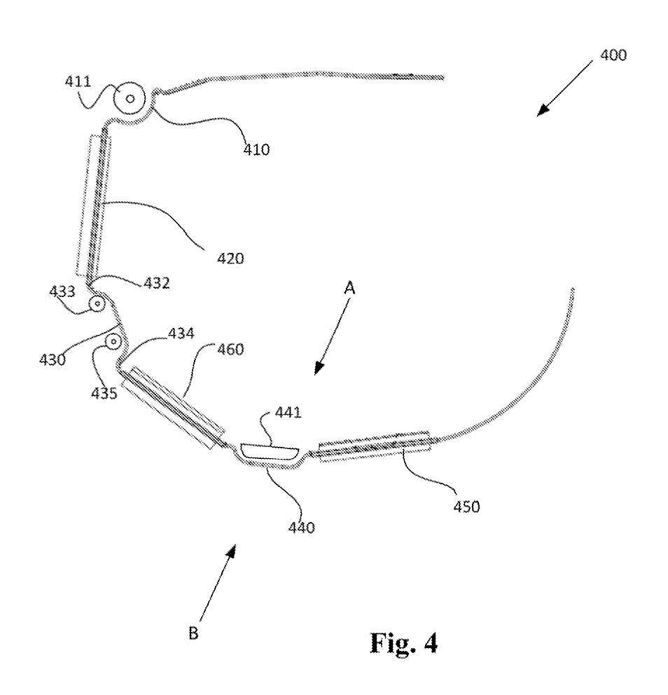

According to an implementation of the disclosed subject matter, an antenna contained within a flexible section of a band may be located at a position within the flexible section such that the antenna is not in contact with a user's skin when the wearable device containing the device is worn by the user. As shown in FIG. 4, the wearable device band may contain two sides, side A and side B. Side A may be the side facing a user when the wearable device is worn by the user. Side B may be the side facing away from the user while the wearable device is worn by the user. Although this disclosure may refer to the two sides as an upper side and a lower side, it will be understood that the upper side generally refers to side B (i.e., the side facing away from the user) and lower side generally refers to side A (i.e., the side facing the user). The antenna within a flexible section may be located closer to the upper side than the lower side such that there is a greater distance between the antenna and the lower side of the flexible section than the antenna and the upper side of the flexible section. Accordingly, the antenna is positioned such that there is a given distance between the antenna and the user's skin. The distance may reduce the interference caused by any electromagnetic fields generated by the user's skin. Thus, the performance of the antenna may improve based on being a certain distance away from the user's skin. The antenna may contain a top side and a bottom side such that the top side of the antenna faces the upper side of the band and the bottom side of the antenna faces the lower side of the band. As an example, an antenna's top side may be flush with the upper side of a band (i.e., 0 mm between the top side of the antenna and the top side of the band) and the antenna's bottom side may face the lower side of the band. The distance between the bottom side of the antenna and the lower side of the band may be a given distance (e.g., 5 mm) such that when a user wears the wearable device containing the band, the user's skin touches the lower side of the band. An electromagnetic field generated by the user's skin may be less likely to cause interference with the antenna based on the distance between the user's skin and the antenna.

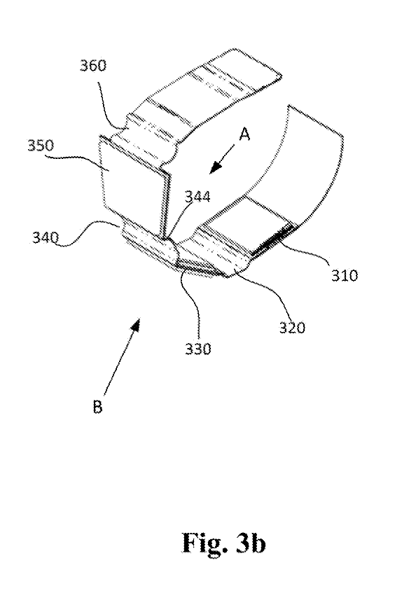

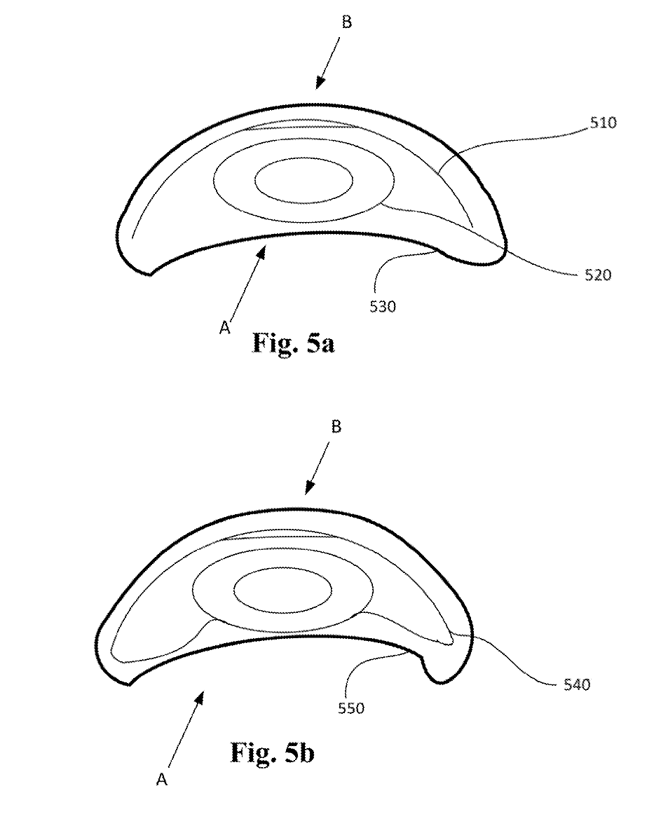

According to an implementation of the disclosed subject matter, a flexible section of a wearable device band may either contain a roller or may be located above a roller. It will be understood that although the present disclosure describes the roller as a part of a flexible section that is part of a band, a flexible section may be placed over a roller. As an example, as shown in FIG. 5, a band 530 may contain a flexible section 510 that is located above a roller 520. Here, side A indicates the lower side of the band that would be in contact with a user wearing the wearable device and side B indicates the upper side facing away from the user. A roller may be mechanically connected to a flexible section in any applicable manner such as via mechanical connection points. FIG. 5b shows an example of a band 550 containing a flexible section 540 that includes a roller. A roller may be made of any applicable material such as plastic, cloth, wood, or the like and may insulate against electromagnetic fields. The roller may enable the band to stretch or bend in on or more directions, such as when a user is securing the band onto the user's body. As an example, a watch band may contain one or more flexible sections including rollers. A user may place the watch on the user's wrist and pull two ends of the band towards each other to secure the watch on the wrist. As the user pulls the two ends, the band may stretch as a result of the pulling. Here, rigid sections of the watch band may not change their structure whereas one or more flexible sections may stretch over their respective rollers while changing their shape to conform to the roller and also enabling the watch band to switch from a not worn to worn shape. More specifically, as the flexible section stretches due to a force (e.g., caused by a user pulling), the shape of the flexible section may conform to the shape of the roller located under the flexible section. According to an implementation, a flexible section may be located over two or more rollers. The two or more rollers may operate similarly to a single roller, as disclosed herein. As an example, FIGS. 3a and 3b show a wrist watch with a flexible section 340. The flexible section may be placed above two rollers such that flex points 342 and 344 bend over both rollers. Both rollers, over which flex points 342 and 344 flex, may shape the flexible section. As shown in FIG. 4, a roller may be located on a side facing away from a user wearing the wearable device (i.e., side B and roller 411), or, alternatively, a roller may be located on a side facing a user wearing the wearable device (i.e., side A and roller 441). According to implementations of the disclosed subject matter, a roller may be a single component or may be made of multiple components.

The shape of an antenna contained within a flexible section may or may not change when a portion of the flexible section changes shape by bending or stretching over a roller. The antenna may be flexible such that when the flexible section is bent or stretched over a roller, at least a part of the antenna also changes shape along with the flexible section. Alternatively, the flexible section may be configured such that when a portion of the flexible section is bent or stretched over a roller, the antenna associated with the flexible section does not change shape. More specifically, portions of the flexible section around the antenna may change shape to accommodate any stretching, while the antenna maintains its shape.

According to implementations of the disclosed subject matter, a grounding flap may be located beneath an antenna. The grounding flap may prevent user contact such that any unintended voltage is not transferred from the user to the antenna. Further, the grounding flap may also be connected to any other electronic circuit such as the radio frequency circuit or the central processing unit. For example, the grounding flap may be attached to a common ground plane used by at least one of the radio frequency circuit and/or the central processing unit. A grounding flap may be connected to a flexible section with an antenna in any applicable manner such as soldered into one or more solder points on one or more sides of a flexible section, received by contact points located on the flexible section, integrated into a flexible section. The grounding flap may remain in a relative position as at least a part of the flexible section and/or the antenna shifts when the band containing the flexible section is stretched. Notably, the grounding flap remaining relatively stationary may reduce stress on the solder points while at least a portion of the flexible section flexes. The grounding flap may be located adjacent to a roller such that the grounding flap may be above, below or shifted physically, relative to a roller. A grounding flap located above a roller may change a shape when the roller is stretched. Alternatively, a grounding flap located beneath a roller may maintain its shape when a portion of the flexible section is bent or stretched above the roller.

Another rigid section containing a central processing unit may be located on the side of the flexible section opposite of the rigid section with the radio frequency circuit. Here, the flexible section may be contained between the rigid section with the radio frequency circuit and the rigid section with the central processing unit. As an example, as shown in FIG. 3a, a wearable device may contain a band 300. The band 300 may contain a first rigid section 310 that contains a central processing unit and a second rigid section 330 that contains an RF circuit. A flexible section 320 may be located between the first rigid section 310 and the second rigid section 330. The flexible section 320 may contain an antenna, as disclosed herein. The antenna may be electrically connected to at least the radio frequency circuit and may be driven by the radio frequency circuit. For example, the radio frequency circuit may provide a signal to the antenna to transmit a specific signal at a given frequency. As another example, the antenna may receive a signal and electronically communicate it to the radio frequency circuit. The radio frequency circuit may be in connection with the central processing unit.

In an illustrative example of the disclosed subject matter, as shown in FIGS. 3a and 3b, a watch band 300 may contain a first rigid section 310 and a second rigid section 330. The first rigid section 310 may contain a central processing unit and the second rigid section 330 may contain a radio frequency circuit. The radio frequency circuit may be electronically connected to an antenna located in the flexible section 320. The antenna may be located closer to side B (i.e., away from a user wearing the watch), than side A. Additionally, the flexible section 320 may contain a roller over which the flexible section bends when the watch band is pulled. A grounding flap 325 may be connected to the flexible section 320 and may be located below the roller, towards side A (i.e., proximate to a user wearing the watch). A second flexible section 340 may be located adjacent to the second rigid section and may not contain an antenna. The second flexible section may be placed over two rollers and may be configured to change shape based on the shape of the rollers such that flex points 342 and 344 bend or stretch over the two rollers. A display 350 may be located on the band 300 and a third flexible section 360 may be located adjacent to the display 350.

In another illustrative example of the disclosed subject matter, as shown in FIG. 4, a watch band 400 may contain a first flexible section 410. Flexible section 410 may bend over roller 411. A display 420 may be adjacent to the first flexible section and a second flexible section 430 may contain an antenna. Two rollers 433 and 435 may allow flex sections 432 and 434 to bend around them and the rollers 433 and 435 and flex sections 432 and 434 may be located within the second flexible section 430. The second flexible section may contain an antenna located closer to side B (i.e., away from a user wearing the watch) such that there is at least 5 mm of distance between the bottom of the antenna and the lower side of the watch band. A second rigid section 460 may contain a radio frequency circuit and may be adjacent to a third flexible section 440. The third flexible section 440 may be located adjacent to a third rigid section 450 which may contain a central processing unit. The third flexible section 440 may bend around roller 441, as shown.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A device comprising:
a band comprising:
a plurality of flexible and rigid sections;
a first rigid section of the plurality of rigid sections;
a radio frequency circuit on a second rigid section of the plurality of rigid sections;
a first flexible section of the plurality of flexible sections between the first rigid section and the second rigid section; and
a second flexible section of the plurality of flexible sections having an antenna element and disposed adjacent to the second rigid section.

2. The device of claim 1, wherein the first rigid section comprises a central processing unit.

3. The device of claim 1, wherein the second rigid section comprises a central processing unit.

4. The device of claim 1, wherein the first flexible section and the second flexible section are the same flexible section.

5. The device of claim 2, wherein the first flexible section and the second flexible section are the same flexible section.

6. The device of claim 1, wherein the antenna element has a top side and a bottom side and the band further comprising a roller element disposed beneath the bottom side of the antenna element.

7. The device of claim 6, wherein a first roller element is mechanically connected to the first flexible section.

8. The device of claim 6, wherein a second roller element is mechanically connected to the second flexible section.

9. The device of claim 1, wherein the antenna element is electrically connected to the radio frequency circuit.

10. The device of claim 6, wherein the roller element is an electrical insulator.

11. The device of claim 1, further comprising a grounding flap.

12. The device of claim 11, wherein the grounding flap is integrated into the second flexible section.

13. The device of claim 11, wherein the grounding flap is configured to be received by a contact point within the second flexible section.

14. The device of claim 11, wherein a grounding flap solder point is located within the second flexible section

15. The device of claim 11, wherein the grounding flap is mechanically connected to the second flexible section.

16. The device of claim 11, wherein the grounding flap is adjacent to the roller element.

17. The device of claim 15, wherein the grounding flap is electrically connected to the radio frequency circuit.

18. The device of claim 6, wherein the band is a wrist band having an upper and a lower side.

19. The device of claim 18, wherein the roller element is disposed to maintain a minimum distance of the antenna element from the inside of the wrist band when the wrist band is bent.

20. The device of claim 18, wherein the antenna element is at least 5 mm away from the outside of the wrist band.

21. The device of claim 6, wherein the second flexible section is configured to bend around the roller.

22. The device of claim 21, wherein the antenna element bends when the second flexible section bends around the roller.

23. The device of claim 21, wherein the antenna element shape remains unchanged when the second flexible section bends around the roller.

24. The device of claim 1, further configured to be in connection with a display.

25. The device of claim 1, wherein the antenna element is integrated into the second flexible section.

26. The device of claim 1, wherein the antenna element is soldered onto the second flexible section.
